(19) United States
(12) Patent Application Publication
(10) Pub. No.: US 2010/0255343 A1
(43) Pub. Date: Oct. 7, 2010

(54) COMPRESSOR

(76) Inventors: Yuuichi Takagi, Saitama (JP); Shunji Komatsu, Gunma (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(21) Appl. No.: 12/596,407

(22) PCT Filed: Apr. 18, 2008
(86) PCT No.: PCT/JP2008/057591

§ 371 Date: Oct. 16, 2009

(30) Foreign Application Priority Data
Apr. 19, 2007 (JP) 2007-110462

(51) Int. Cl. B32B 9/00; C25D 7/00; B32B 15/00

(52) U.S. Cl. 428/688; 205/50; 428/411.1

(57) ABSTRACT

A compressor using a refrigerant containing a compound having a double bond characterized in that any one selected from a Fe—P-based electroplated film, a Fe—W-based electroplated film, a Fe—C-based electroplated film, a Fe—N-based electroplated film, a Co-based electroplated film, a Co—W-based electroplated film, a Cr-based electroplated film, a Cr—Mo-based electroplated film, a resin-coated film and a DLC-surface-treated film is employed as a coating layer for an internal structural member. The occurrence of an additional reaction of the refrigerant containing a compound having a double bond can be suppressed, and an excellent performance of the compressor can be exhibited for a long term.

### TECHNICAL FIELD OF THE INVENTION

The present invention relates to a compressor using a refrigerant containing a compound having a double bond, and specifically, to a compressor suitably used for an air conditioning system for vehicles.

### BACKGROUND ART OF THE INVENTION

As a conventional refrigerant for an air conditioning system for vehicles, hydrofluoro carbon (HFC) has been used as an alternate Freon. Although the ozone depletion potential (ODP) of hydrofluoro carbon is 0, its global warming potential (GWP) is relatively great.

By the way, in EU countries, use of a refrigerant with a GWP of 150 or less is obligated by the year of 2011. Therefore, a refrigerant containing a compound including a carbon double bond such as hydrofluoro olefin, whose GWP is relatively small, is also proposed (Patent document 1).

On the other hand, in a compressor used in a refrigeration circuit of an air conditioning system for vehicles, in order to prevent an abrasion and the like of an internal structural member, Ni-based electroplated, etc. is applied to the internal structural member, in particular, to a sliding part (for example, in case of a swash plate type compressor, to a sliding surface between a shoe and a swash plate).

However, in case where a refrigerant containing a compound having a carbon double bond (hereinafter, also referred to as a new refrigerant) is used to the above-described conventional air conditioning system for vehicles, Ni contained in a coating layer of an internal structural member of a compressor may act as a catalyst, and therefore, there is a fear that the compound having a carbon double bond causes an additional reaction. If such an additional reaction is accelerated, the composition of the refrigerant may be greatly impaired, and the compression efficiency of the compressor, ultimately, the refrigeration efficiency of the refrigeration circuit may be reduced.

Patent document 1: U.S. Pat. No. 6,858,571B2

### DISCLOSURE OF THE INVENTION

### Problems to be Solved by the Invention

Accordingly, an object of the present invention is to provide a compressor which can surely suppress an additional reaction of a refrigerant containing a compound having a carbon double bond and which can exhibit an excellent performance stably for a long term.

### Means for Solving the Problems

To achieve the above-described object, a compressor according to the present invention is a compressor using a refrigerant containing a compound having a double bond, and is characterized in that any one selected from the group consisting of a Fe—P-based electroplated film, a Fe—W-based electroplated film, a Fe—C-based electroplated film, a Fe—N-based electroplated film, a Co-based electroplated film, a Co—W-based electroplated film, a Cr-based electroplated film, a Cr—Mo-based electroplated film, a resin-coated film and a DLC-surface-treated film is employed as a coating layer for an internal structural member of the compressor. As the resin-coated film, for example, a film of polytetrafluoro ethylene (PTFE), etc. can be exemplified. Where, the DLC (Diamond Like Carbon) coating layer means a coating layer of an amorphous carbon hydride.

The above-described coating layer for an internal structural member of the compressor preferably does not contain a catalytic metal at all which acts as a catalyst at the time of an additional reaction of the compound having a double bond. Namely, it is a compressor using a refrigerant containing a compound having a double bond, and is characterized in that any one selected from the group consisting of a Fe—P-based electroplated film, a Fe—W-based electroplated film, a Fe—C-based electroplated film, a Fe—N-based electroplated film, a Co-based electroplated film, a Co—W-based electroplated film, a Cr-based electroplated film, a Cr—Mo-based electroplated film, a resin-coated film and a DLC-surface-treated film is employed as a coating layer for an internal structural member of the compressor, and the coating layer does not contain a catalytic metal at all which acts as a catalyst at the time of an additional reaction of the compound having a double bond.

In the above-described structure of the compressor, as the coating layer, any one selected from a Fe—P-based electroplated film, a Fe—W-based electroplated film, a Fe—C-based electroplated film, a Fe—N-based electroplated film, a Co-based electroplated film, a Co—W-based electroplated film, a Cr-based electroplated film, a Cr—Mo-based electroplated film, a resin-coated film and a DLC-surface-treated film is used, and these do not act as a catalyst at the time of an additional reaction of a compound having a carbon double bond such as hydrofluoro olefin. Therefore, the additional reaction of the compound having a carbon double bond can be suppressed, and because the composition of the refrigerant is not greatly impaired, the compression efficiency, etc. of the compressor can be maintained to be good for a long term.

As the above-described internal structural member of the compressor, a sliding member of the compressor can be exemplified. For example, because a sliding member having a sliding surface between a shoe and a swash plate in a swash plate type compressor is liable to be abraded by sliding accompanying with operation of the compressor and it comes into contact with refrigerant, particularly the coating layer preferably does not contain a catalytic metal at all which acts as a catalyst at the time of an additional reaction of the compound having a double bond.

The refrigerant used in the compressor according to the present invention contains a compound having a carbon double bond such as a hydrofluoro olefin. As such a hydrofluoro olefin (HFO), for example, the following compounds shown by Chemical formulae 1-3 can be raised.

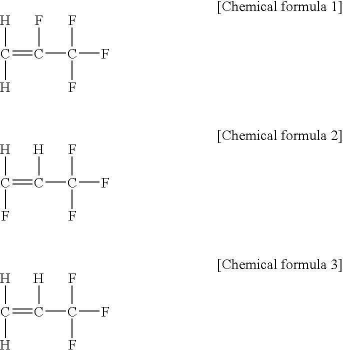

### EFFECT ACCORDING TO THE INVENTION

In the compressor according to the present invention, as the coating layer of the internal structural member, any one selected from a Fe—P-based electroplated film, a Fe—W-based electroplated film, a Fe—C-based electroplated film, a Fe—N-based electroplated film, a Co-based electroplated film, a Co—W-based electroplated film, a Cr-based electroplated film, a Cr—Mo-based electroplated film, a resin-coated film and a DLC-surface-treated film is used, and these do not act as a catalyst at the time of an additional reaction of a compound having a carbon double bond such as hydrofluoro olefin. Therefore, the additional reaction of the compound having a carbon double bond can be suppressed, and because the composition of the refrigerant is not greatly impaired, the compression efficiency, etc. of the compressor can be maintained to be good stably for a long term.

As the internal structural member, for example, a sliding member of a swash plate type compressor, which has a sliding surface between a shoe and a swash plate, can be exemplified, and because such a sliding member is liable to be abraded by sliding accompanying with operation of the compressor and it comes into contact with refrigerant, by preparing it as one that does not contain a catalytic metal at all which acts as a catalyst at the time of an additional reaction of the compound having a double bond, the additional reaction can be suppressed more effectively.

### BRIEF EXPLANATION OF THE DRAWINGS

FIG. 1 is a vertical sectional view of a swash plate type compressor according to an embodiment of the present invention.

FIG. 2 is a partial, enlarged sectional view of the compressor depicted in FIG. 1.

### EXPLANATION OF SYMBOLS

1: swash plate type compressor

2: cylinder block

3: front housing

4: cylinder head

5: crank chamber

6: swash plate

6a: one surface of swash plate

6b: the other surface of swash plate

7: shaft

8a, 8b: bearing

9: shoe

10: piston

11: end portion of piston

12: recessed portion

14: cylinder bore

15: rotor

16: selvage part

17: slot

18: hole

19: pin member

20: thrust bearing

21: bush

22: spring

23: inner wall

24: suction chamber

25: discharge chamber

26: suction hole

27: discharge hole

28a, 28b: coating layer on surface of swash plate

29: coating layer on surface of shoe

### THE BEST MODE FOR CARRYING OUT THE INVENTION

Hereinafter, desirable embodiments of the compressor according to the present invention will be explained referring to figures.

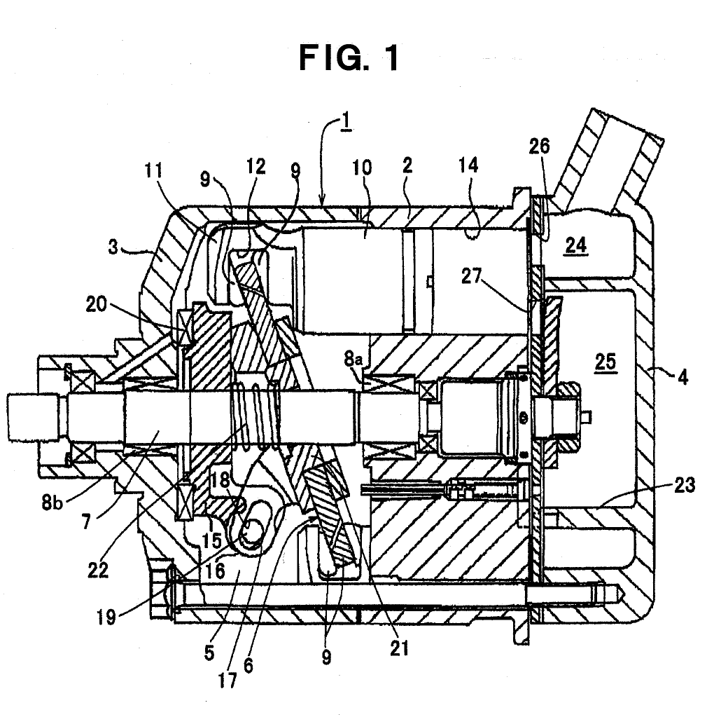

FIG. 1 depicts a compressor according to an embodiment of the present invention, and in FIG. 1, the compressor is formed as a swash plate type compressor. In FIG. 1, a swash plate type compressor 1 is constructed as a compressor used in a refrigeration circuit of an air conditioning system for vehicles, and as its refrigerant, a refrigerant containing a compound having a carbon double bond such as a hydrofluoro olefin is used.

Swash plate type compressor 1 has a cylinder block 2. A front housing 3 is connected to one end portion of cylinder block 2, and a cylinder head 4 is connected to the other end portion of cylinder block 2. The inside of the space surrounded by cylinder block 2 and front housing 3 is formed as a crank chamber 5, and in the crank chamber 5, a swash plate 6 is disposed. A shaft 7 (a drive shaft) is inserted through nearly the center of swash plate 6. Shaft 7 is supported free to rotate by cylinder block 2 and front housing 3 via bearings 8a and 8b.

A pair of shoes 9 are provided free to slide at the outer circumferential end portion of swash plate 6. Shoes 9 are engaged free to swing in a recessed portion 12 which is formed in an end portion 11 at crank chamber 5 side of a piston and in which spherical concave surfaces are formed. Piston 10 is provided free to reciprocate in a cylinder bore 14 provided to cylinder block 2.

Further, a selvage part 16 extending toward a rotor 15 is provided on one surface 6a of swash plate 6. A hole 18 is opened on selvage part 16 in correspondence with a slot 17 provided on rotor 15, and a pin member 19 is inserted into slot 17 and hole 18 so that swash plate 6 and rotor 15 are substantially connected to each other even when the inclination angle of swash plate 6 is changed.

Rotor 15 is rotated integrally with shaft 7 while it is thrust supported via a thrust bearing 20 on the inner wall of front housing 3. Swash plate 6 is engaged with a bush 21 provided movably in the axial direction on shaft 7, and is changed in its inclination angle accompanying with the axial movement of the bush 21. A spring 22 is interposed between rotor 15 and bush 21.

The inside of cylinder head 4 is divided into a suction chamber 24 and a discharge chamber 25 by an inner wall 23. Suction chamber 24 is communicated with cylinder bore 14 through a suction hole 26. On the other hand, discharge chamber 25 is communicated with cylinder bore 14 through a discharge hole 27.

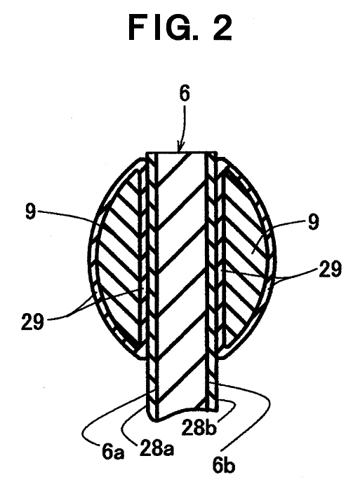

The coating layer according to the present invention is provided to an internal structural member of swash plate type compressor 1. For example, the coating layer is provided to a sliding portion formed by swash plate 6 and shoes 9. Concretely, as depicted in FIG. 2, surfaces 6a and 6b of swash plate 6 are covered with coating layers 28a and 28b. Further, the surfaces of shoes 9 are covered with coating layer 29. For the coating layers 28a, 28b and 29, any one selected from a Fe—P-based electroplated film, a Fe—W-based electroplated film, a Fe—C-based electroplated film, a Fe—N-based electroplated film, a Co-based electroplated film, a Co—W-based electroplated film, a Cr-based electroplated film, a Cr—Mo-based electroplated film, a resin-coated film and a DLC-surface-treated film can be employed. However, the above-described films are raised as examples for the coating layer, and the coating layer is not limited thereto. Namely, the above-described coating layer may be one that does not contain a catalytic metal at all which acts as a catalyst at the time of an additional reaction of a compound having a carbon double bond such as hydrofluoro olefin.

In this embodiment, since for the internal structural any one selected from a Fe—P-based electroplated film, a Fe—W-based electroplated film, a Fe—C-based electroplated film, a Fe—N-based electroplated film, a Co-based electroplated film, a Co—W-based electroplated film, a Cr-based electroplated film, a Cr—Mo-based electroplated film, a resin-coated film and a DLC-surface-treated film, namely, one that does not contain a catalytic metal at all which acts as a catalyst at the time of an additional reaction of a compound having a carbon double bond such as hydrofluoro olefin, is used, even in case where the refrigerant contains a compound having a carbon double bond such as hydrofluoro olefin, the additional reaction of the compound having a carbon double bond can be suppressed, and therefore, the composition of the refrigerant is not greatly impaired. Therefore, the compression efficiency, etc. of the compressor may be maintained to be good stably for a long term.

### INDUSTRIAL APPLICATIONS OF THE INVENTION

The compressor according to the present invention can be applied to any compressor using a refrigerant containing a compound having a carbon double bond, and in particular, it is suitable as a compressor used in a refrigeration circuit of an air conditioning system for vehicles.

1. A compressor using a refrigerant containing a compound having a double bond characterized in that any one selected from the group consisting of a Fe—P-based electroplated film, a Fe—W-based electroplated film, a Fe—C-based electroplated film, a Fe—N-based electroplated film, a Co-based electroplated film, a Co—W-based electroplated film, a Cr-based electroplated film, a Cr—Mo-based electroplated film, a resin-coated film and a DLC-surface-treated film is employed as a coating layer for an internal structural member of said compressor.

2. The compressor according to claim 1, wherein said coating layer for an internal structural member of said compressor does not contain a catalytic metal at all which acts as a catalyst at the time of an additional reaction of said compound having a double bond.

3. The compressor according to claim 1, wherein said internal structural member is a sliding member of said compressor.

4. The compressor according to claim 1, wherein said compound having a double bond is hydrofluoro olefin.

5. The compressor according to claim 1, wherein said compressor is a compressor for an air conditioning system for vehicles.
